(19) United States
(12) Patent Application Publication
(10) Pub. No.: US 2008/0208694 A1
(43) Pub. Date: Aug. 28, 2008

(54) CONCESSION TRAY

(76) Inventor: David I. Baggott, Ogden, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/045,586

(22) Filed: Mar. 10, 2008

Related U.S. Application Data
(63) Continuation-in-part of application No. 10/754,222, filed on Jan. 9, 2004, now Pat. No. 7,341,005.
(60) Provisional application No. 60/493,501, filed on Aug. 8, 2003.

(51) Int. Cl. A47C 7/62; A47C 1/12; G06Q 30/00

(52) U.S. Cl. 705/14; 297/146

(57) ABSTRACT

A concession tray that selectively supports a plurality of concessions or light-weight items in a substantially horizontal position relative to a stadium seat. Generally, the concession tray comprises a supporting tray portion, a transitional mechanism, and/or a coupling mechanism. The tray portion comprises a substantially planar surface configured to support light-weight items when in the horizontal position. The transitional mechanism allows the concession tray to be pivotally moved between a substantially vertical stowed position and the substantially horizontal use position. The coupling mechanism is configured to mount or selectively couple the concession tray to a supporting object, such as a one or more stadium seats. The concession tray may incorporate advertising thereon as a means to generate revenue for a stadium, theater, or arena in which it resides.

### RELATED APPLICATIONS

This application is a continuation-in-part of U.S. patent application Ser. No. 10/754,222, filed Jan. 9, 2004, entitled “CONSESSION TRAY,” which claims priority to U.S. Provisional Patent Application Ser. No. 60/493,501, entitled “CONSESSION TRAY,” filed Aug. 8, 2003, both of which are incorporated herein by reference.

### BACKGROUND OF THE INVENTION

1. Field of the Invention

The present invention relates to concession trays. In particular, embodiments of the present invention relate to systems and methods for providing a collapsible tray apparatus that is selectively coupled to seating in a stadium or arena for supporting food, beverages, and other light-weight items.

2. Background

Patrons and spectators at sporting events, concerts, and theaters are typically seated in multiple rows of seats arranged in an inclined or stepped-up stadium tier arrangement. Stadium seats typically comprise a seating portion and a backrest portion, each of which is supported laterally on either side by a seat standard having an armrest portion that may be shared between spectators. A seating portion may be pivotally attached to each seat standard to enable a seat portion to be stowed substantially adjacent the backrest portion when a stadium seat is not occupied. In between the rows or tiers are relatively narrow aisles that permit access to and from interiorly disposed stadium seats. Such aisles also provide space for a spectator's feet and legs when the spectator is seated.

Stadiums, theaters, and arenas commonly provide concessions and encourage their patrons to purchase and enjoy such concessions during an event. Once purchased, however, a patron must take care to avoid spills or other mishaps that may occur as a result of the patron having to manually support or balance the concessions, or having to place the concessions in the aisle area near the patron's feet. As a result, a patron's attention is often diverted from the event to the care of the purchased concessions, thereby reducing the patron's enjoyment of the event.

This problem is exacerbated when a patron purchases more than one concession, or when the patron is a child. Indeed, although holding or balancing one concession may be uncomfortable for a patron, holding or balancing more than one concession is often impossible. Further, children may lack the coordination necessary to effectively hold or balance a purchased concession at all. The temperature of the concession may also make manual retention of the concession difficult or undesirable.

Thus, while techniques and apparatus currently exist that are used to hold food or beverages in stadium settings, challenges still exist, including those previously mentioned. Accordingly, it would be an improvement in the art to augment or even replace current techniques and apparatus.

### SUMMARY OF THE INVENTION

The present invention relates to concession trays. In particular, embodiments of the present invention relate to systems and methods for providing a collapsible tray apparatus that is selectively coupled to seating in a stadium or arena for supporting food, beverages, and other light-weight items.

At least some implementations of the present invention embrace a concession tray for selectively supporting a plurality of concessions or light-weight items in a substantially horizontal position relative to a stadium seat, thereby facilitating the comfort and enjoyment of a patron at a performance or event. Generally, the concession tray comprises a supporting tray portion, a transitional mechanism, and/or a coupling mechanism. The tray portion comprises a substantially planar surface configured to support light-weight items. The transitional mechanism allows the concession tray to be pivotally moved between a substantially vertical stowed position and a substantially horizontal use position. The coupling mechanism is configured to mount or selectively couple the concession tray to a supporting object, such as a one or more stadium seats. In some implementations, the concession tray incorporates advertising thereon as means to generate revenue for a stadium, theater or arena in which it resides. In this manner, the concession tray may be easily and inexpensively implemented in a performance venue, and may also be used to generate revenue therefor.

These and other features and advantages of the present concession tray will be set forth or will become more fully apparent in the description that follows and in the appended claims. The features and advantages may be realized and obtained by means of the instruments and combinations particularly pointed out in the appended claims. Furthermore, the features and advantages of the concession tray may be learned by its practice or will be obvious from the description, as set forth hereinafter.

### BRIEF DESCRIPTION OF THE DRAWINGS

In order that the manner in which the above recited and other features and advantages of the described concession tray are obtained, a more particular description of the concession tray will be rendered by reference to specific embodiments thereof, which are illustrated in the appended drawings. Understanding that the drawings depict only typical embodiments of the present concession tray and/or associated components and are not, therefore, to be considered as limiting in scope, the concession tray will be described and explained with additional specificity and detail through the use of the accompanying drawings in which:

FIG. 1A is a perspective view of a representative embodiment of a concession tray;

FIG. 1B is a perspective view of a representative embodiment of the concession tray;

FIG. 2 is a perspective view of a stadium seat assembly that implements a representative embodiment of a concession tray;

FIG. 3A is a perspective view of a representative embodiment of a concession tray in a first horizontal position;

FIG. 3B is a perspective view of a representative embodiment of a concession tray in a second vertical position;

FIG. 3C is a perspective view of a representative embodiment of a concession tray stowed against a backrest of a stadium seat;

FIG. 4 is a perspective view of a representative embodiment of a concession tray;

FIG. 5 is a perspective view of a representative embodiment of a concession tray;

FIG. 6 is a flow chart delineating an example of a representative method for providing a stadium seat assembly with an embodiment of the present invention;

FIG. 7 is a side view illustrating a representative embodiment of a transitional mechanism for a concession tray;

FIG. 8 is a side view illustrating a representative embodiment of a transitional mechanism for a concession tray;

FIG. 9 shows a representative embodiment where a concession tray is selectively coupled to a stadium seat;

FIG. 10 shows a perspective view of a representative embodiment of a concession tray; and

FIG. 11 shows a perspective view of a representative embodiment of a concession tray.

### DETAILED DESCRIPTION

The described systems, apparatus, components, and associated methods may be embodied in other specific forms without departing from their spirit or essential characteristics. The described embodiments are to be considered in all respects only as illustrative and not restrictive. The scope of the devices, systems, components, and associated methods, therefore, are indicated by the appended claims rather than by the foregoing description. All changes that come within the meaning and range of equivalency of the claims are to be embraced within their scope.

The present invention relates to concession trays. In particular, embodiments of the present invention relate to systems and methods for providing a collapsible tray apparatus that is selectively coupled to seating in a stadium or arena for supporting food, beverages, and other light-weight items.

As used in this specification, the term “stadium” refers to a stadium, theater, arena, performance hall, or other performance venue having seating accommodations for a plurality of spectators or patrons. The term “stadium seat” or “seat” refers to a structure capable of supporting the weight of a patron or spectator in an indoor or outdoor stadium, theater, arena, performance hall, or other performance venue. The term “concession tray” or “tray” refers to a substantially planar structure for supporting food, beverages, and/or other concessions or lightweight items.

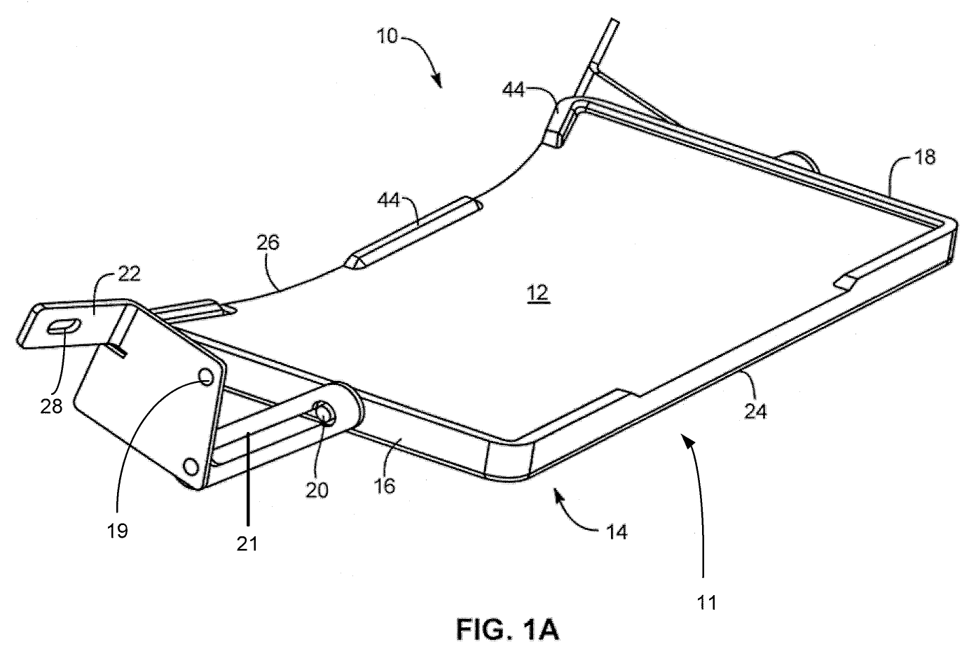

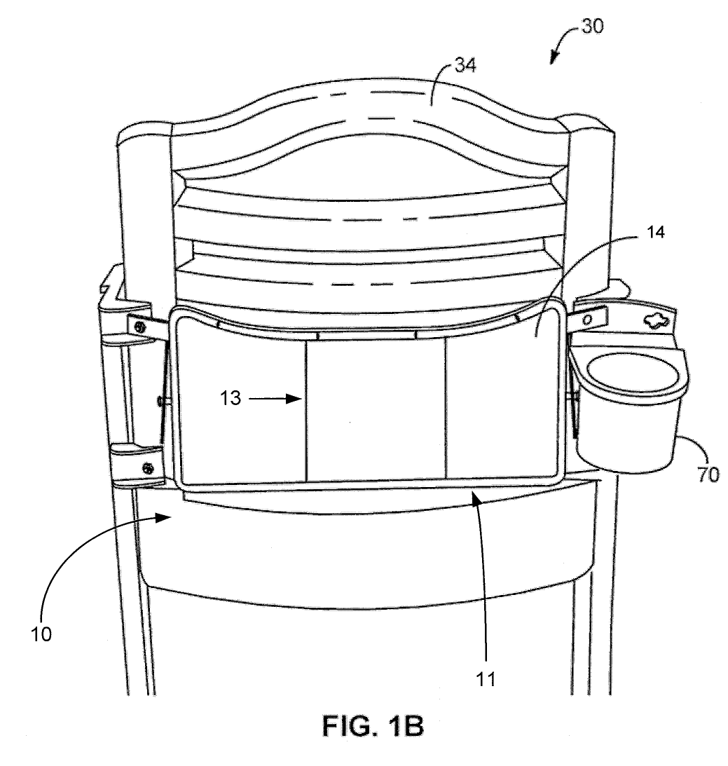

Generally, this specification discusses a tray apparatus for supporting food, beverages, and/or other light-weight items. More particularly, this specification discusses a concession tray apparatus that can be collapsible as well as be mounted or selectively coupled to one or more stadium seats. Although the concession tray may comprise any suitable component, FIG. 1A shows that, in some embodiments, the concession tray 10 comprises a supporting tray portion 11, a transitional mechanism (e.g., pivoting means 20) for moving the tray portion between a plurality of positions, and/or a coupling mechanism (e.g., retaining flange 22) for attaching the concession tray 10 to a supporting object. In order to provide a better understanding of the concession tray and its use with a supporting object, the supporting object and each of the aforementioned components is respectively described below in more detail.

The concession tray may be mounted or selectively coupled in a removable fashion to any suitable object that can be configured to support the concession tray, including, but not limited to, one or more stadium seats, supports, cup holders, bleachers, seating section dividers, railings, ledges, or other objects in a stadium that are in front of and in proximity to a stadium seat. Indeed, in some preferred embodiments, the concession tray may be supported by one or more stadium seats.

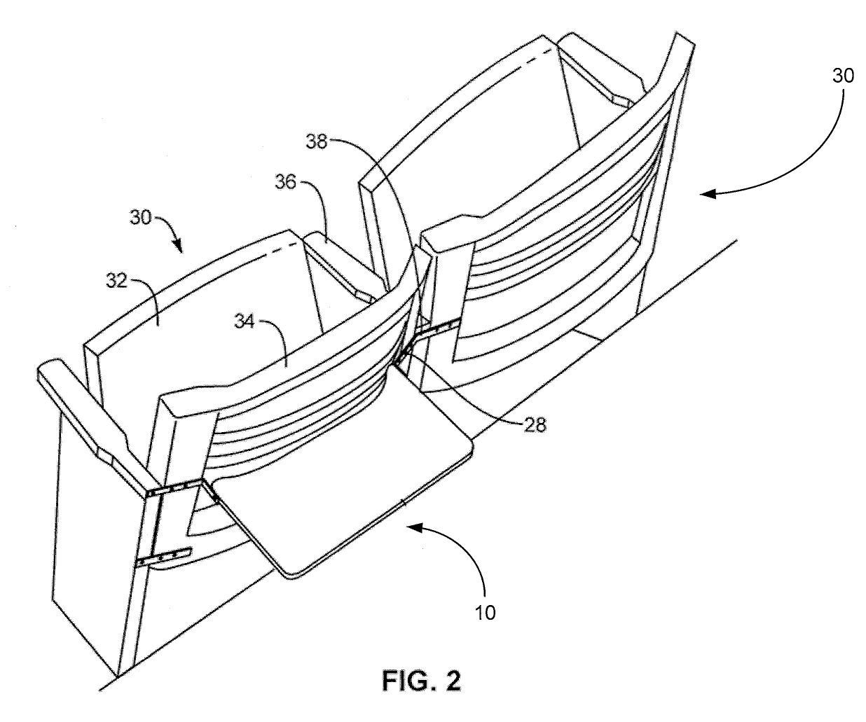

By way of non-limiting example, FIGS. 1B and 2 show some instances where the concession tray 10 is supported by a stadium seat 30. Such a stadium seat can comprise any suitable characteristic. For example, FIG. 2 shows a stadium seat 30 that comprises a seat portion 32 and a backrest portion 34 that extends in a substantially vertical direction. The backrest 34 and seat 32 portions comprise metal, wood, fiberglass, plastic, composite, or any other durable, comfortable material known to those in the art. Often, the seat portion 32 of typical stadium seats 30 can be folded up, automatically or otherwise, when the seat 30 is not in use. This function maximizes space between rows of seats 30 to facilitate access to internal seats 30 via stadium aisles.

A stadium seat 30 may be supported on either side by a structural support 36 mounted to the floor, a stadium tier, or other suitable object. The structural support 36 may be fabricated from metal, such as steel, aluminum, cast iron, or any other material known to those in the art. The structural support 36 may serve a dual function in both providing a secure base for a stadium seat 30, as well as providing an independent or shared armrest between neighboring spectators. A stabilizing element 38 may be attached to a distal end of the structural support 36 and to one or more neighboring stadium seats 30 to lend stability to the side-by-side relationship between the neighboring seats 30.

At least some embodiments of the present invention comprise a concession tray, in some cases having a tray portion. The tray portion can have virtually any characteristic or component that allows it to support food, beverages, or other light-weigh items. By way of example, FIG. 1A shows the tray portion 11 comprises a substantially planar supporting surface 12 for supporting food, beverages and/or other light-weight items. FIG. 1B shows that, in some embodiments, the tray portion 11 comprises a back surface 14. Moreover, FIG. 1A shows that one or more lateral edges (e.g., a first lateral surface 16 and a second lateral surface 18) can run substantially perpendicular to and separate the supporting surface 12 from the back surface 14.

The supporting surface may have any characteristic that allows it to fulfill its intended purpose. For example, FIG. 1A shows the supporting surface 12 comprises a substantially rectangular shape having a distal edge 26 configured to complement the shape of a backrest portion 34 of a stadium seat 30 (shown in FIG. 1B). In another example, FIG. 1A also shows the supporting surface 12 comprises a proximal edge 24 with any suitable characteristic. For instance, the proximal edge 24 curves inwardly to accommodate a spectator's body. Alternatively, the proximal edge 24 may maintain a straight profile or bow outwardly to maximize a surface area of the supporting surface 12. In addition to the previously mentioned shapes and configurations, the supporting surface 12 may be configured to resemble any shape having any dimensions known to those in the art that accommodate concessions and/or spectators.

FIG. 1A shows a representative embodiment where the supporting surface 12 includes an elevated lip 44 around at least a portion of its outer perimeter to facilitate retention of items thereon. The lip may have any characteristic compatible with its described purpose. For instance, the lip can be any suitable elevation. In one example, the lip extends from about 0.01 inches to about 5 inches above the supporting surface. In another example, the lip extends from about 0.25 inches to about 1 inch above the supporting surface. In a preferred example, however, the lip has an elevation of about 0.5 inches.

The back surface of the tray portion may have any characteristic suitable for use with the concession tray. By way of non-limiting example, the back surface may be substantially flat, substantially curved, run substantially opposite to and/or parallel with the supporting surface, and so forth. For instance, FIG. 1B shows the back surface 12 can be substantially flat and comprise support braces 13 that can strengthen the tray portion 11.

The tray portion and its various components may be made of any material that allows it and/or its components to support or retain concessions or other light-weight items. Some non-limiting examples of suitable materials may include one or more metals, plastics, synthetic polymers, composites, natural substances (e.g., wood or other organic fiber), or any other suitable materials that can be formed to create one or more components of the tray portion. Although the tray portion and its various components may be made of multiple materials, in some embodiments, it may be preferred to form the tray portion and its various components of a single material.

In certain aspects, the concession tray incorporates advertising in any suitable manner. For example, the tray portion 11 can incorporate advertising on or in connection with its supporting and/or back surfaces 12 and 14 such that the advertising is visible both when the tray portion 11 is in a use position and/or when it is collapsed in a stored position. Such advertising may comprise print advertisements, adhesive advertisements, electronic advertisements, or advertisements of any other form known to those in the art. Advertising may comprise laminate applied to the supporting 12 and/or back 14 surface of the tray portion 11, print integrated into one or more surfaces of the concession tray 10, paper or electronic advertisements inserted behind a transparent portion on a surface of the concession tray 10, or any other means of advertising known to those in the art. Alternatively, advertisements may be applied or integrated into a backrest portion 34 of a stadium seat 30, a beverage holder 70, or any other location conducive to spectator viewing.

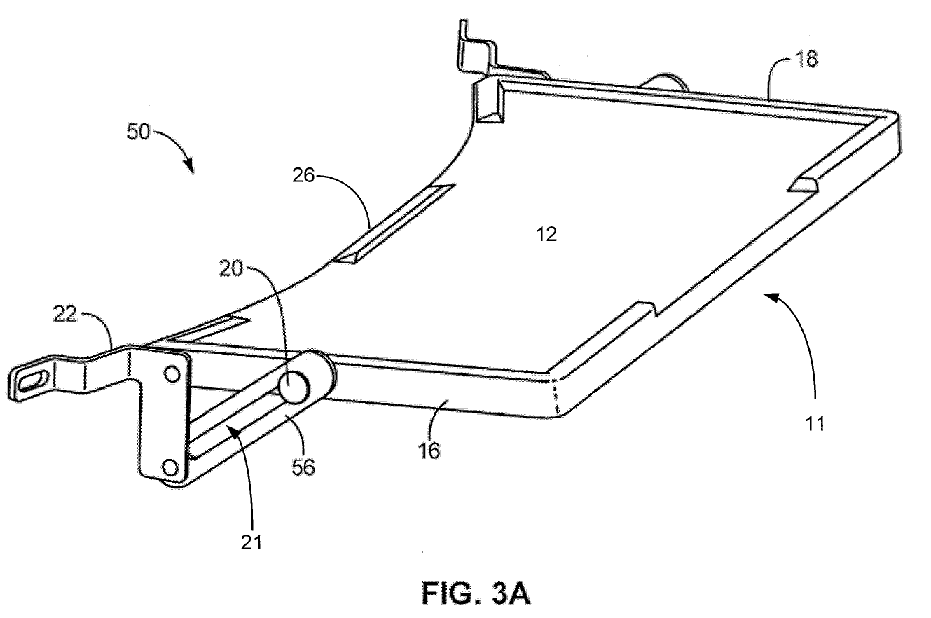

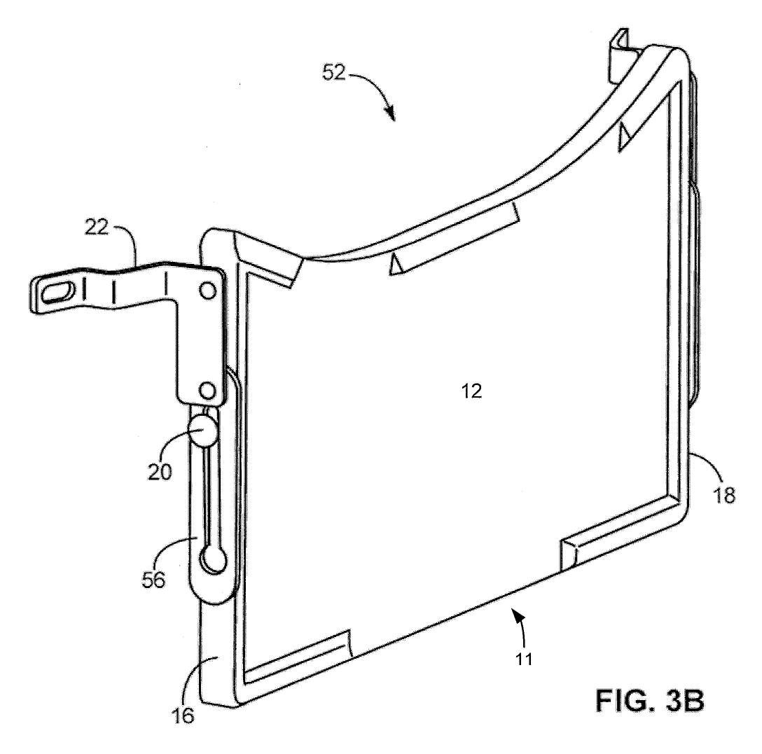

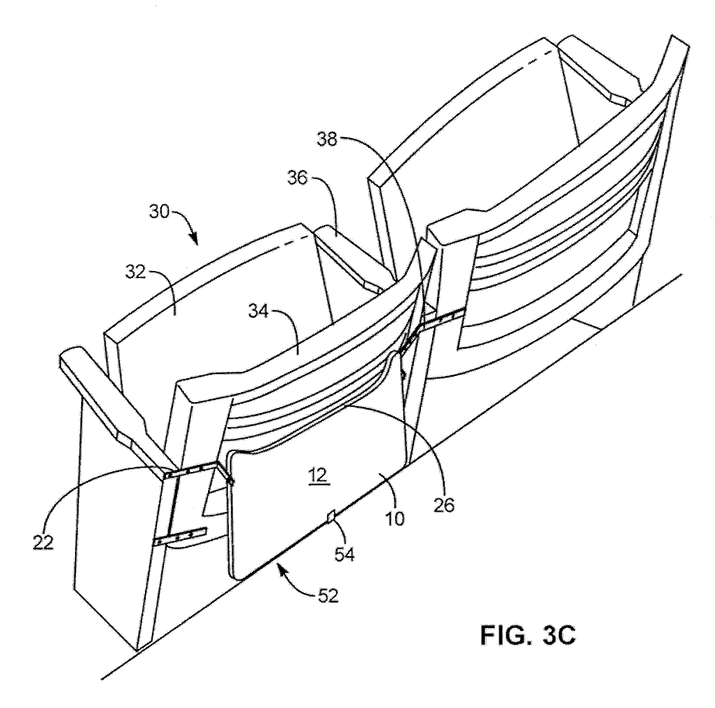

Although in some embodiments the concession tray is not collapsible, in other embodiments, it includes a transitional mechanism that allows the tray portion to be moved from a first position to a second position. While the tray portion may be movable between any desired positions, FIG. 3A shows a representative embodiment where the first position 50 is a use position, wherein the supporting surface 12 is substantially level or horizontal. In this first position 50, the distal edge 26 of the tray portion 11 can have a substantially adjacent relationship between the backrest portion 34 of a stadium seat 30.

Conversely, FIG. 3B shows a representative embodiment where the second position 52 is a stowed position, wherein the supporting surface 12 runs substantially vertical. The second position 52 may result from collapsing the tray portion from the first position 50 such that a supporting surface 12 of the concession tray resides substantially parallel and/or adjacent to the backrest portion 34 of a stadium seat 30. Alternatively, the second position 52 comprises a substantially adjacent and/or parallel relationship between the back surface 14 of the tray portion 11 and the backrest portion 34 of a stadium seat 30.

The transitional mechanism may be any suitable mechanism that allows the tray portion to be moved between a plurality of positions, such as the first and second positions discussed above. Some non-limiting examples of suitable transitional mechanisms may include a pivoting mechanism, a sliding mechanism, or combinations thereof. In one example, FIG. 1A shows the transitional mechanism can comprise a first pivoting means 19 and a second pivoting means 20, wherein the pivoting means 19 and/or 20 comprise a bolt, a pin, a ball joint, or any other means known to those in the art. This example shows the first pivoting means 19 may serve to pivotally connect the lateral edge surfaces 16 and/or 18 of the tray portion 11 to the coupling mechanism (e.g., retaining flange 22). Further, this example shows the second pivoting means 20 may move through a slot 21 that limits the amount the tray portion 11 can pivot.

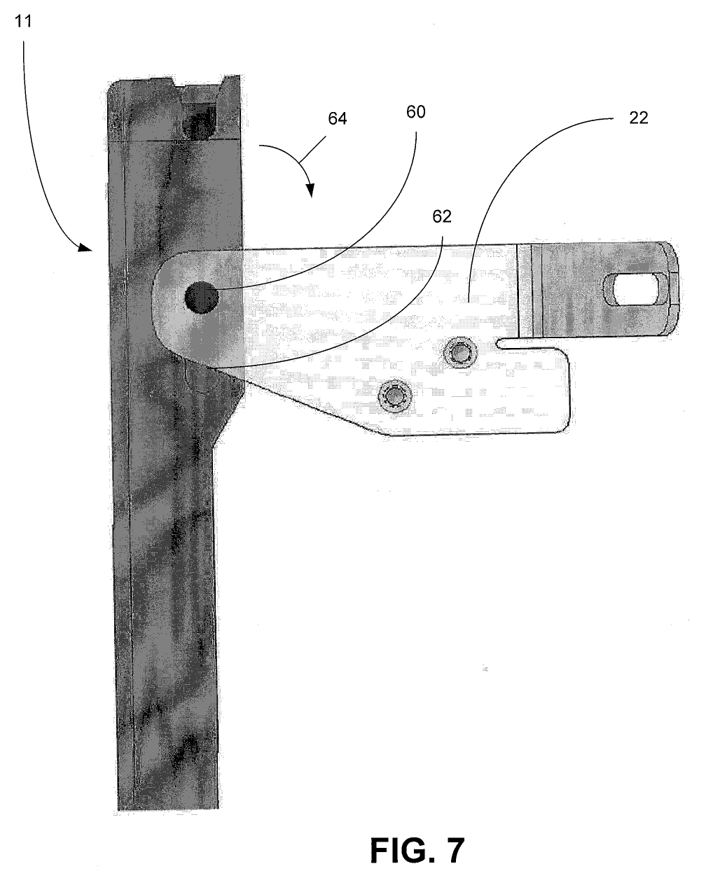

In another example, FIG. 7 illustrates that the transitional mechanism comprises single pivot means 60 that is configured to slide in channel 62. While channel 62 and pivot means 60 may be disposed on the coupling mechanism (e.g., retaining flange 22) and tray portion 11, respectively, FIG. 7 shows a representative embodiment where pivot means 60 is disposed on retaining flange 22 and where channel 62 is disposed on tray portion 11. In this example, the tray portion 11 pivots around pivot means 60 in, or opposite to, the direction of arrow 64 so as to be moved between the first and the second position. Moreover, in this example, the tray portion may be slide back and forth so as to engage a locking mechanism, as described below.

In at least one embodiment, retaining flange 22 is selectively received by a receiving bracket (not shown) mounted on a surface, such as a stadium seat or support, located in front of a user. The receiving bracket is configured to selectively receive at least a portion of retaining flange 22 to enable selective and removable attachment of concession tray 10 to the surface.

In another example, concession tray 10 is independent of a stadium seat 30 such that at least one coupling mechanism (e.g., a retaining flange 22) retains the tray portion 11 in the first position 50 by permitting the concession tray 10 to balance thereon in a substantially horizontal position relative to the backrest 34 of a stadium seat 30, rather than by positively securing the concession tray 10 in position. According to this example, a second position 52 that is substantially adjacent and/or parallel to the backrest 34 may be achieved by manually lifting the concession tray 10 from its first balanced position 50 and placing it against the backrest 34. This second position 52 may be facilitated by coupling retaining brackets to the backrest 34, wherein the brackets are configured to receive and retain the concession tray 10 in the second position 52.

According to some embodiments, the tray portion may be selectively retained in a desired position (e.g., the first or second position) by a locking mechanism. In such embodiments, the locking mechanism may comprise any component or characteristic suitable to selectively retain the tray portion in a desired position. Some non-limiting examples of such components may include, but are not limited to, one or more springs, toothed wheels, bearing pins, catches, protuberances and grooves, or any other means known to those in the art which can maintain the support portion in either a substantially horizontal or vertical position.

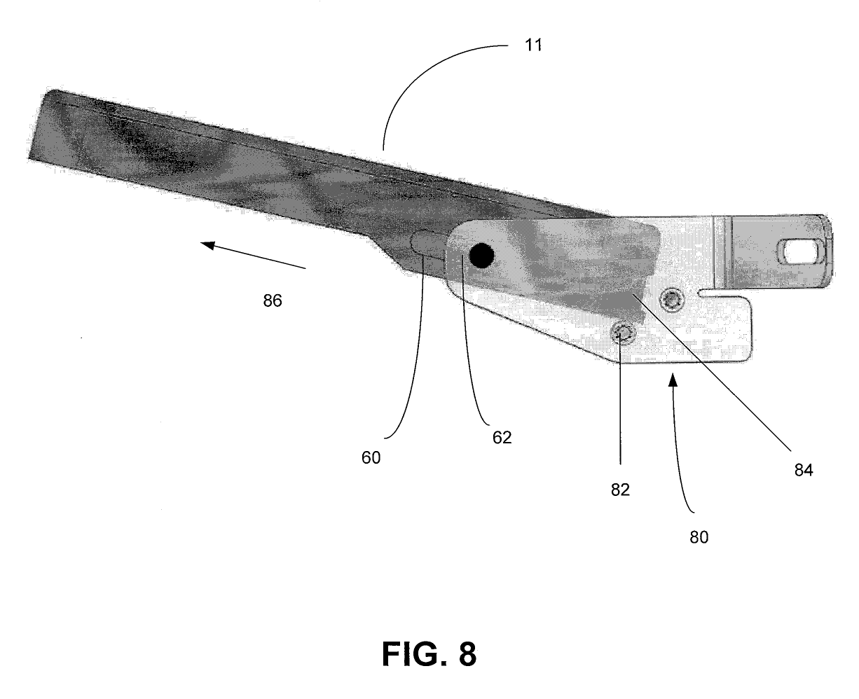

In one example, FIG. 3A shows a locking mechanism 56 that secures the tray portion 11 in its first position 50. In this example, the second pivot means 20 can be caught by a catch at one end the slot 21. In another example, FIG. 8 shows the locking mechanism 80 can comprise a protuberance 82 and a groove 84. Some non-limiting examples of the protuberance include a bin, bolt, bump, etc. In this example, when the tray portion 11 is in the first position, pivot means 60 can slide in channel 62 so that groove 84 in tray portion 11 engages protuberance 82 in a manner that retains tray portion 11 in the first position. To move the tray portion from this locked position, tray portion 11 may be pulled away from protuberance 82 in the direction of arrow 86 so that the tray portion can freely rotate about the pivot means 60. Accordingly, the described locking mechanisms may be selectively released to enable the concession tray to collapse adjacent the backrest and preserve space when not in use.

The concession tray may also include a locking mechanism that serves to selectively retain the tray portion in the second position, including, but not limited to, one or more catches, magnets, releasable fasteners, turn locks, etc. In one example, FIG. 3C shows the locking mechanism comprises a turn lock 54, which can be rotatably connected to the backrest portion 34 to releasably lock the concession tray 10 in the second position 52.

The concession tray may also comprise a coupling mechanism that serves to attach the concession tray to one or more objects, such as a stadium chair, a seating section divider, a bleacher, railing, etc. However, in some preferred embodiments, the coupling mechanism is configured to attach the concession tray to the back of at least one stadium seat.

The coupling mechanism may have any characteristic that allows it to be mounted to a suitable supporting object. For instance, where the coupling mechanism couples the concession tray to a stadium seat, the coupling mechanism may comprise any component or characteristic that allows it to mount the concession tray to a stadium seat. For example, the coupling mechanism comprises a retaining flange that comprises a stationary hinge, a bracket, a bolt, a pin, or any other means known to those in the art capable of connecting the tray portion 11 and/or transitional mechanism to a stadium seat 30. For example, FIG. 1A shows the coupling mechanism can comprise the retaining flange 22 in the form of a bracket.

According to certain embodiments, the dimensions and configuration of the retaining flange 22 correspond to existing hardware used to secure the assembly of a stadium seat 30. In this manner, retaining flange 22 can be attached to stadium seat 30 without requiring substantial modification of the stadium seat 30, if any. In addition, the concession tray 10 may be implemented on a large scale basis in connection with a plurality of stadium seats 30 in a performance venue while substantially limiting costs associated with materials and labor.

According to certain embodiments, retaining flange 22 may be connected to stabilizing element 38 of a stadium seat 30 to facilitate implementation of the concession tray 10 relative to backrest 34 of a stadium seat 30. Specifically, retaining flange 22 can comprise an aperture 28 that corresponds to an opening in the stabilizing element 38 used to receive a bolt or other hardware to fix the stabilizing element 38 against a stadium seat 30. The hardware used to secure stabilizing element 38 against a stadium seat 30 may be adapted to also secure retaining flange 22 against a stadium seat 30. In this manner, the concession tray 10 may be securely implemented against backrest portion 34 of a stadium seat 30 while minimizing costs of hardware and labor associated with such implementation.

According to certain embodiments, the coupling mechanism is configured to selectively couple the concession tray to one or more supporting objects, including those previously mentioned. In such embodiments, the concession tray may be easily attached for use and/or easily removed. Accordingly, the concession tray may be removed for venues where concessions are inappropriate, it may only be provided to patrons who purchase concessions, it may be purchased and be used by patrons in one or more stadiums, it may be rented by patrons for a particular venue, it removed for cleaning or repair, and so forth.

The concession tray may comprise any coupling mechanism that serves to selectively couple the concession tray to a supporting object, such as stadium seating. Some non-limiting examples of suitable coupling mechanisms that can selectively couple the concession tray to an object include one or more brackets, straps, tongues and grooves, mating slides, catches, mounts, magnets, clamps, fasteners, harnesses, bands, or other components or mechanisms that can selectively attach the concession tray to an object.

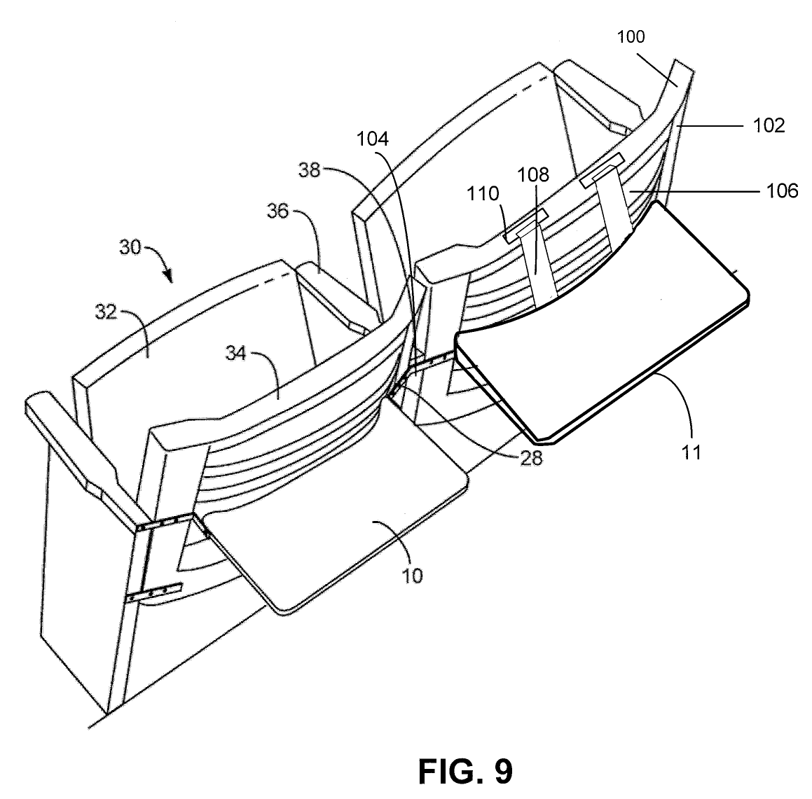

In some embodiments, the concession tray may be selectively coupled to a stadium seat by one or more brackets. In such embodiments, the brackets may selectively couple the concession tray to any portion of the seat, including, but not limited to, the structural support 36, a top edge 100, one or more sides edges (e.g., 102 and 104), or a back portion 106 of the backrest 34. In one example, FIG. 9 shows two brackets 108 may selectively couple the tray portion 11 to the top edge 100 of the backrest 34. Although the brackets 108 may be configured to extend across the width of the top edge, FIG. 9 shows a representative embodiment where brackets 108 only extend across a portion of the top edge 100 and are selectively disposed in recesses 110. In some cases, such a configuration may be preferable so that the occupant of the seat is not bothered by the brackets.

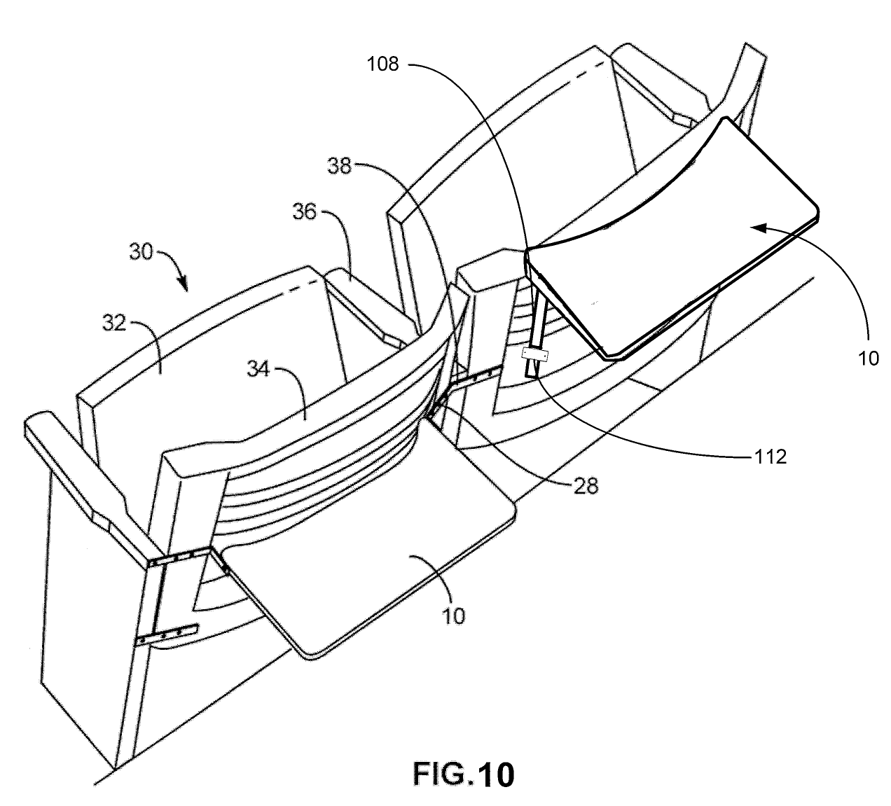

In another example, FIG. 10 shows that brackets, or another selective coupling mechanism, may be used to selectively couple the concession tray 10 above the top edge 100 of the backrest 34. Indeed, such a configuration may be beneficial where the backrest of the seat is below the comfortable use range of a patron sitting directly behind the seat. Although the concession tray 10 may be selectively coupled above backrest 34 in any suitable manner, FIG. 10 illustrates some embodiments where one or more brackets 108 is slidably connected to a mount 112 so as to selectively attach the concession tray to the seat.

In another example that is not illustrated, the brackets may be configured to extend from the sides of the concession tray and be shaped to hold the concession tray to the sides of the backrest. In this example, the brackets may be positioned above the top edge of the backrest and lowered until each bracket engages a side surface 102 or 104 of the backrest. Conversely, the concession tray in this example may be uncoupled from the chair by sliding the concession tray and brackets up and off the sides of the backrest.

In yet another example that is not illustrated, the tray portion may be configured to slide into grooves that are associated with the backrest. In a final example, the tray portion or another component of the concession tray may be selectively clipped or snapped into a mating receptacle on the stadium seat.

Regardless of the selective coupling mechanism employed, in some embodiments, the selective coupling mechanism may optionally include a locking mechanism that selectively maintains the concession tray coupled to a supporting object. Indeed, the selective coupling mechanism may comprise any locking mechanism that allows the concession tray to be releasably attached to a supporting object (e.g., a seat), including, but not limited to, a spring loaded plunger that can be engaged when the concession tray is coupled and can be disengaged to decouple the concession tray from the supporting object.

When the concession tray is uncoupled from the seat, the tray may be stored in any suitable manner. For example, the concession tray 10 may be stowed beneath the seat portion 32 of a stadium seat 30 by sliding the concession tray 10 into retaining brackets contained on an underside thereof, by simply placing the concession tray 10 on the floor beneath a stadium seat 30, by stowing the tray 10 between stadium seats 30, by being collected and stored, or by any other means known to those in the art.

In addition to the aforementioned characteristics, the concession tray may comprise any other suitable characteristic. For example, the concession tray may be selectively coupled to an object and comprise a transitional mechanism so that the concession tray is both collapsible and selectively detachable from the object. However, in other embodiments, the concession tray may not have a transitional mechanism. In such embodiments, the concession tray can be selectively coupled to an object even though it may not be collapsible.

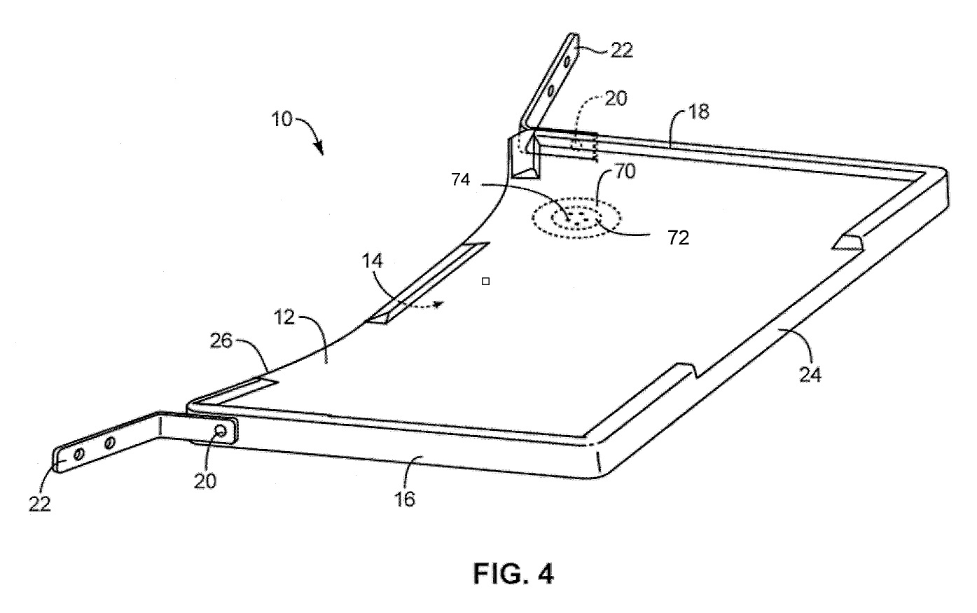

Additionally, in some embodiments, the concession tray comprises a beverage holder 70 integrated into, coupled to, or implemented proximate the concession tray 10. Referring now to FIG. 4, a beverage holder 70 may comprise a hole or recessed portion 72 integrated into a supporting surface 12 of the concession tray. The recessed portion 72 may comprise a size and configuration appropriate to receive a standard-sized beverage container. For example, the recessed portion 72 may comprise a recessed circle having a diameter just larger than a standard drinking cup. Alternatively, the recessed portion 72 may comprise any shape that may function to receive and retain food and/or beverage products, such as a square, rectangle, oval, octagon, or any other appropriate shape known to those in the art. The depth of a recessed portion 72 can also be of a sufficient depth to reduce the risk of a food or beverage product falling or tipping over, preferably within about two to four inches. The recessed portion 72 may also have drain holes 74 for spills or to facilitate cleaning.

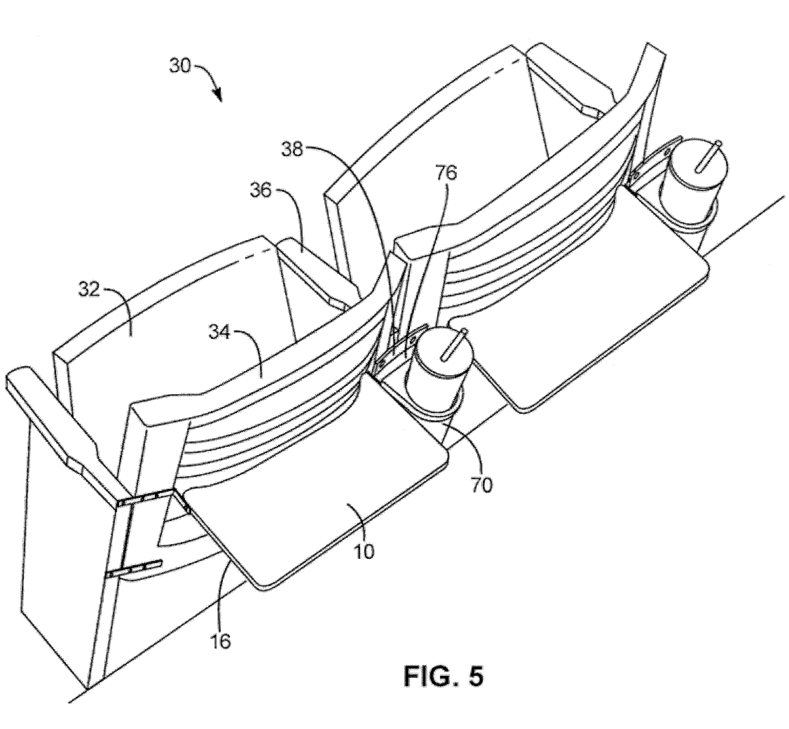

In another example, FIG. 5 shows the beverage holder 70 may comprise an independent cup holder receptacle 76 (e.g., a cup holder) attached to the concession tray 10 or to a stadium seat 30. Preferably, the holder receptacle 76 can be connected to a distal edge of a structural support 36 residing between neighboring stadium seats 30. In this manner, the holder receptacle 76 may be used independently of the concession tray 10 and may maintain a secure relationship with respect to a stadium seat 30. Indeed, as the structural support 36 is directly mounted to the floor or a stadium tier, it can provide stable and reliable support, even under tumultuous conditions. Alternatively, the holder receptacle 76 may comprise a supporting rim 78 integrated into or coupled to the concession tray 10 such that a beverage may be retained by the supporting rim 78 proximate and substantially parallel to the supporting surface 12 of the concession tray 10. One or more supporting brackets may be coupled to the supporting rim 78 to further stabilize a beverage placed therein. A holder receptacle 76 may be pivotally or slidably attached to a concession tray 10 or to a stadium seat 30 to facilitate stowing the holder receptacle 76 when the holder receptacle 76 is not in use. The holder receptacle 76 may also have drain holes 74 therein to facilitate cleaning.

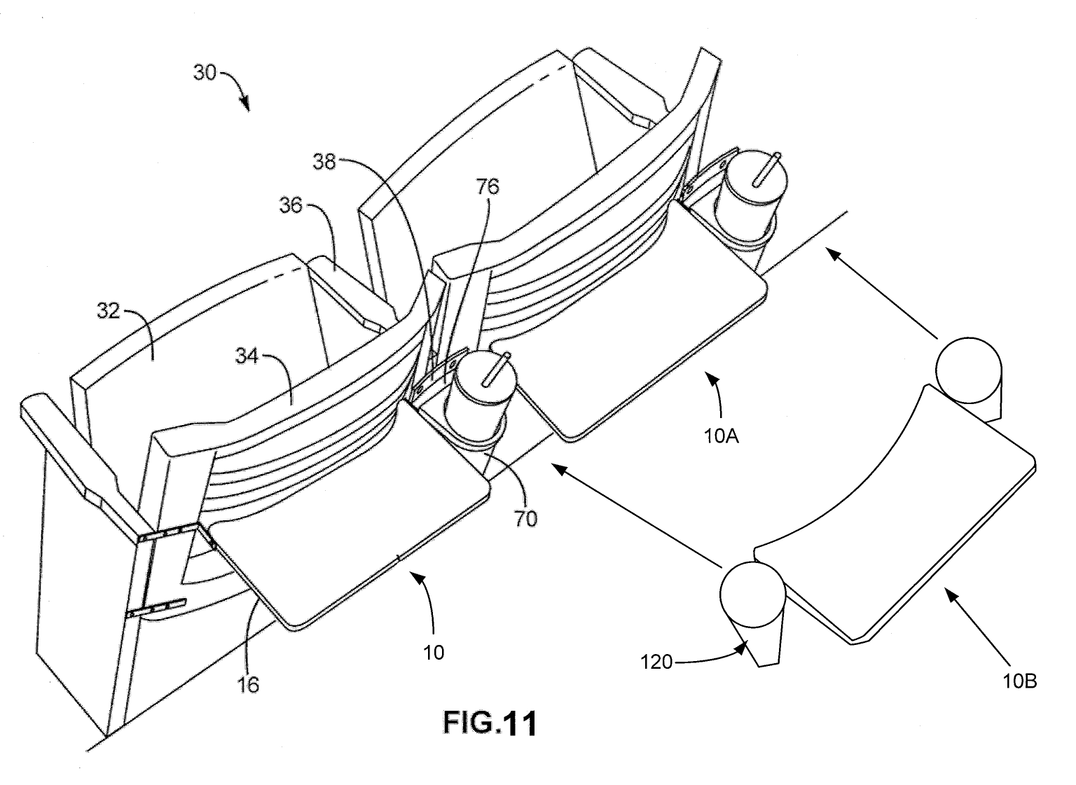

In addition to holding a beverage or other light-weight item, the holder receptacle 76 may also be used to support some embodiments of the concession tray. Although the concession tray may be selectively coupled to one or more holder receptacles in any suitable manner, FIG. 11 shows some instances where the concession tray 10B comprises one or more mating elements 120, such as the illustrated cup-shaped appendages. In this example, when the holder receptacles 76 are empty and the first concession tray 10A has been removed or moved to the second position, the mating elements 120 of the second concession tray 10B may be inserted into the holder receptacles 76.

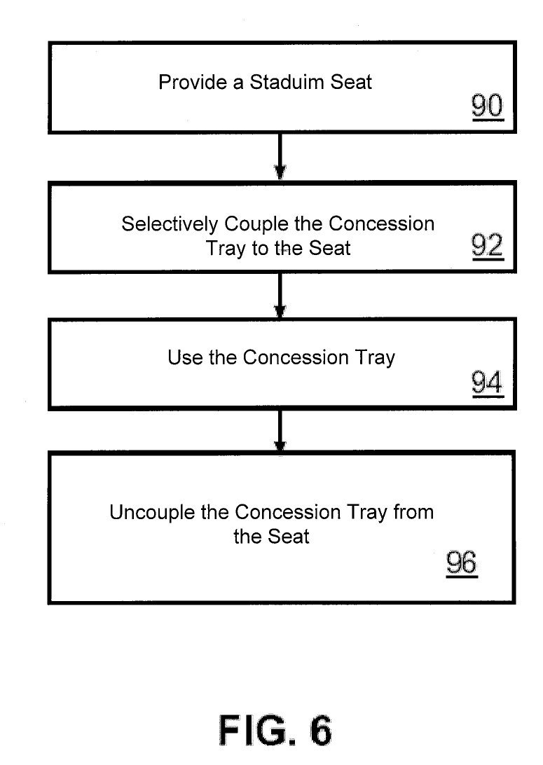

While the concession tray may be used in any suitable manner, FIG. 6 shows a non-limiting example of a method for its use. Specifically, at 90, FIG. 6 shows the method can begin by providing a stadium seat 30, wherein the stadium seat 30 comprises a backrest portion 34, a seat portion 32, and a structural support portion 36. Next at 92, the concession tray may be selectively coupled to the stadium seat in any suitable manner. For example, brackets on the concession tray may be placed over the top edge 100 of the seat so that the concession tray is releasably supported by the top edge of the seat.

At 94, FIG. 6 shows that once coupled, the concession tray may be used in any suitable manner. For instance, concessions or light-weight objects can be placed on the concession tray and the tray portion can be moved into the first and/or second position, as desired. Finally, at 96 the concessions tray may be uncoupled from the seat for a desired purpose. The process can then be repeated, as desired.

Thus, as discussed herein, embodiments of the present invention embrace concession trays. In particular, embodiments of the present invention relate to systems and methods for providing a collapsible tray apparatus that is selectively coupled to seating in a stadium or arena for supporting food, beverages, and other light-weight items.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A concession tray apparatus comprising:
a supporting tray portion configured to selectively support concessions of a user when said supporting tray portion is in a horizontal use position, wherein the supporting tray portion comprises a supporting surface and a bottom surface;
a coupling mechanism configured to selectively and removeably couple the concession tray apparatus to a supporting object that is located in front of a stadium seat; and
a transitional mechanism configured to allow the supporting tray portion to pivot between a vertical stowed position and a horizontal use position, wherein the supporting surface of the supporting tray portion faces outwardly when in the vertical stowed position, wherein the transitional mechanism comprises:
a single pivoting means that pivotally connects the supporting tray portion to the coupling mechanism, wherein the pivoting means is configured to slide in a channel so as to engage a locking mechanism to selectively retain the supporting tray portion in the horizontal use position.

2. The concession tray apparatus of claim 1, wherein the supporting object comprises at least one stadium seat.

3. The concession tray apparatus of claim 2, wherein the bottom surface of the supporting tray portion is substantially adjacent to a backrest portion of the at least one stadium seat when the supporting tray portion is in the vertical stowed position.

4. The concession tray apparatus of claim 2, wherein the coupling mechanism is configured to selectively couple the concession tray apparatus to a portion of the stadium seat selected from a top edge of a backrest portion, a side edge of the backrest, and a back portion of the backrest.

5. The concession tray apparatus of claim 4, wherein the coupling mechanism is configured to support the concession tray apparatus from the top edge of the backrest portion.

6. The concession tray apparatus of claim 1, wherein the coupling mechanism further comprises a locking mechanism configured to selectively retain the concession tray apparatus coupled to the supporting object.

7. The concession tray apparatus of claim 1, wherein the coupling mechanism is configured to selectively couple the concession tray apparatus to at least one cup holder receptacle that acts to support the concession tray.

8. The concession tray apparatus of claim 1, wherein the supporting surface of the supporting tray portion comprises a substantially planar supporting surface having dimensions sufficient to support a plurality of concessions.

9. The concession tray apparatus of claim 7, further comprising advertising on the substantially planar supporting surface of the supporting tray portion to enable the advertising to be viewed in both the stowed and in the use position.

10. The concession tray apparatus of claim 1, wherein the supporting tray portion comprises a retaining lip disposed around at least of portion of a perimeter of the supporting surface.

11. A concession tray apparatus comprising:
a supporting object;
a seat assembly, wherein the seat assembly is behind and faces the supporting object;
a supporting tray portion configured to selectively support concessions of a user when said supporting tray portion is in a horizontal use position, wherein the supporting tray portion comprises a supporting surface and a bottom surface;
a coupling mechanism configured to selectively and removably couple the concession tray apparatus to the supporting object; and
a transitional mechanism configured to allow the supporting tray portion to pivot between a horizontal use position and a vertical stowed position, wherein the bottom surface is substantially adjacent to and parallel with a closest surface of the supporting object and the supporting surface of the supporting tray portion faces outwardly when in the vertical stowed position, wherein the transitional mechanism comprises:
a single pivoting means that pivotally connects the supporting tray portion to the coupling mechanism, wherein the pivoting means is configured to slide in a channel so as to selectively engage a locking mechanism in order to retain the supporting tray portion in the horizontal use position.

12. The concession tray apparatus of claim 11, wherein the supporting object comprises at least one stadium seat.

13. The concession tray apparatus of claim 12, wherein the coupling mechanism is configured to support the concession tray apparatus from a top edge of a backrest portion of the at least one stadium seat.

14. The concession tray apparatus of claim 11, wherein the coupling mechanism is configured to selectively couple the concession tray apparatus to at least one cup holder receptacle that acts to support the concession tray.

15. The concession tray apparatus of claim 1, wherein the coupling mechanism further comprises a locking mechanism configured to selectively retain the concession tray apparatus coupled to the supporting object.

16. A method of manufacturing a concession tray apparatus, the method comprising:
providing a supporting tray portion configured to selectively support concessions of a user when said supporting tray portion is in a horizontal use position, wherein the supporting tray portion comprises a supporting surface and a bottom surface;
providing a coupling mechanism configured to selectively couple the concession tray apparatus to a supporting object that is located in front of a stadium seat; and
providing a transitional mechanism configured to allow the supporting tray portion to pivot between a vertical stowed position and a horizontal use position, wherein the supporting surface of the supporting tray portion faces outwardly when in the vertical stowed position, wherein the transitional mechanism comprises:
a single pivoting means that pivotally connects the supporting tray portion to the coupling mechanism, wherein the pivoting means is configured to slide in a channel so as to engage a locking mechanism to selectively retain the supporting tray portion in the horizontal use position.

17. The method of claim 16, wherein the supporting object comprises at least one stadium seat.

18. The method of claim 17, wherein the coupling mechanism is configured to support the concession tray apparatus from a top edge of a backrest portion of the stadium seat.

19. The method of claim 16, wherein the coupling mechanism is configured to selectively couple the concession tray apparatus to at least one cup holder receptacle that acts to support the concession tray.

20. The method of claim 16, the method further comprising advertising on the supporting surface of the supporting tray portion to enable the advertising to be viewed in both the stowed and in the use position.
